(19) United States
(12) Patent Application Publication
(10) Pub. No.: US 2008/0068308 A1
(43) Pub. Date: Mar. 20, 2008

(54) Light-emitting unit system

(75) Inventor: Chiaki Nakajima, Minato-ku (JP)

Correspondence Address: KRATZ, QUINTOS & HANSON, LLP, 1420 K Street, N.W., Suite 400, WASHINGTON, DC, 20005, US

(73) Assignee: KOMADEN CORPORATION, Tokyo (JP)

(21) Appl. No.: 11/522,910

(22) Filed: Sep. 19, 2006

(51) Int. Cl. G09G 3/32

(52) U.S. Cl. 345/82

(57) ABSTRACT

A light-emitting unit system which can efficiently set an address in a light-emitting unit with little labor and can easily check if addresses are normally set is provided.

In the light-emitting unit system, a signal line Sb of the first LED unit is set to logic 1. On the basis of the input of an address write starting signal As, a microprocessor of each LED unit stores an address “1” into a register and sets a signal line Sc, a signal line Sd branched from the signal line Sc to logic 0. On the basis of the input of address write instructing signals Ai, the operating microprocessor judges the logic of the signal line Sb. When the input-side signal line Sb is logic 1, the address “i” stored in the register is written into the nonvolatile memory, the signal line Sc is set to logic 1 so as to turn on a LED, and the signal line Sd is set to logic 1. When the input-side signal line Sb is logic 0, 1 is added to the address “i” stored in the register so as to update the address “i” to an address “i”.

### BACKGROUND OF THE INVENTION

1. Field of the Invention

The present invention relates to a light-emitting unit system which is used as a pixel of an LED display device with a large screen. The light-emitting unit system sets an address in each light-emitting unit on the basis of a control signal input from a bus-connected signal line.

2. Description of the Related Art

A light-emitting unit used as a pixel of an LED display device with a large screen is constructed like an LED unit 10 shown in FIG. 6. In the LED unit 10, three primary colors (R (red), G (green), and B (blue)) of LEDs 11 are arranged on a substrate 12 so as to be lit up, and the LEDs 11 and the substrate 12 are housed in a box-shaped case 13 of which the opening is formed in an oriented direction of the LED 11. Inside the case 13, there are housed an LED driving circuit for controlling the light-emission of the LED 11, a microprocessor, a nonvolatile memory and the like.

An address of the LED unit 10 is set by the input using a DIP switch, and the set address is stored in a nonvolatile memory, as described in the 18th page of JP2001-514432A. Then, when a lighting operation is performed, lighting control signals are transmitted to the addresses of the required LED units 10 among the bus-connected LED units 10, and the LED units 10 at the above-described addresses cause the LEDs 11 to emit light in accordance with the lighting control signals.

In the address setting by the DIP switch, however, an address needs to be set by operating the DIP switch for each LED unit. Therefore, the address setting operation requires considerable labor. Further, such a construction is also desired that can easily check if a required address is normally set in an LED unit or not.

### SUMMARY OF THE INVENTION

An advantage of the invention is that it provides a light-emitting unit system which can efficiently set an address in a light-emitting unit with little labor and can easily check if addresses are normally set.

According to an aspect of the invention, there is provided a light-emitting unit system in which respective light-emitting units having a control section, a nonvolatile memory, and a light-emitting body driving circuit built therein are bus-connected and cascade-connected and which sets an address to the respective light-emitting units on the basis of a control signal input from a bus-connected signal line. An input-side cascade signal line of the first light-emitting unit is set to logic 1. On the basis of a first control signal input from the bus-connected signal line, the control section of each light emitting unit stores a set initial address into a register and sets a signal line between the control section and the light-emitting driving circuit and a cascade signal line branched from the signal line to reach the control section of the next light-emitting unit to logic 0. On the basis of second control signals input from the bus-connected signal line which are sequentially transmitted to correspond to the address setting of the respective light-emitting units, the control section of each light-emitting unit judges the logic of the input-side cascade signal line. When the input-side cascade signal line is logic 1, the address stored in the register is written into the nonvolatile memory, the signal line between the control section and the light-emitting driving circuit is set to logic 1 so as to turn on a light-emitting body, and the cascade signal line branched from the signal line so as to reach the control section of the next light-emitting unit is set to logic 1. When the input-side cascade signal line is logic 0, the next address from the address stored in the register is obtained on the basis of a predetermined operation rule, and the address of the register is updated into the next address.

According to another aspect of the invention, there is provided a light-emitting unit system in which respective light-emitting units having a control section, a nonvolatile memory, and a light-emitting body driving circuit built therein are bus-connected and cascade-connected and which sets an address to the respective light-emitting units on the basis of a control signal input from a bus-connected signal line. An input-side cascade signal line of the first light-emitting unit is set to logic 1. On the basis of a first control signal input from the bus-connected signal line, the control section of each light emitting unit stores a set initial address into a register and sets a signal line between the control section and the light-emitting driving circuit and a cascade signal line branched from the signal line to reach the control section of the next light-emitting unit to logic 0. On the basis of second control signals input from the bus-connected signal line which are sequentially transmitted to correspond to the address setting of the respective light-emitting units, the control section of each light-emitting unit judges the logic of the input-side cascade signal line. When the input-side cascade signal line is logic 1, the signal line between the control section and the light-emitting driving circuit is set to logic 1 so as to turn on a light-emitting body, and the cascade signal line branched from the signal line so as to reach the control section of the next light-emitting unit is set to logic 1. When the input-side cascade signal line is logic 0, the next address from the address stored in the register is obtained on the basis of a predetermined operation rule, and the address of the register is updated into the next address. On the basis of whether the counted input number of second control signals becomes the total number of light-emitting units, or on the basis of the input of a third control signal which is transmitted from the bus-connected signal line after the second control signals are output as many as the total number of light-emitting units, the respective addresses stored in the registers are written into the nonvolatile memories. When normal address setting is impossible, the signal line between the control section and the light-emitting body driving circuit is set to logic 0 so as to turn off the light emitting body.

According to a further aspect of the invention, there is provided a light-emitting unit system in which respective light-emitting units having a control section, a nonvolatile memory, and a light-emitting body driving circuit built therein are bus-connected and cascade-connected to each other and which sets an address to the respective light-emitting units on the basis of a control signal input from a bus-connected signal line. An input-side cascade signal line of the first light-emitting unit is set to logic 1. On the basis of a first control signal input from the bus-connected signal line, the control section of each light-emitting unit sets a signal line between the control section and the light-emitting driving circuit and a cascade signal line branched from the signal line to reach a control section of the next light-emitting unit to logic 0. On the basis of second control signals and addresses input from the bus-connected signal line which are sequentially transmitted to correspond to the address setting of the respective light-emitting units and, the control section of each light-emitting unit judges the logic of the input-side cascade signal line and whether an address is not stored in a register. When the input-side cascade signal line is logic 1 and an address is not stored in the register, the input address is stored in the register and is written into the nonvolatile memory, the signal line between the control section and the light-emitting driving circuit is set to logic 1 so as to turn on a light-emitting body, and the cascade signal line branched from the signal line so as to reach the control section of the next light-emitting unit is set to logic 1.

According to a still further aspect of the invention, there is provided a light-emitting unit system in which respective light-emitting units having a control section, a nonvolatile memory, and a light-emitting body driving circuit built therein are bus-connected and cascade-connected and which sets an address to the respective light-emitting units on the basis of a control signal input from a bus-connected signal line. An input-side cascade signal line of the first light-emitting unit is set to logic 1. On the basis of a first control signal and an initial address input from the bus-connected signal line, the control section of each light emitting unit stores the input initial address into a register and sets a signal line between the control section and the light-emitting driving circuit and a cascade signal line branched from the signal line to reach a control section of the next light-emitting unit to logic 0. On the basis of second control signals input from the bus-connected signal line which are sequentially transmitted to correspond to the address setting of the respective light-emitting units, the control section of each light-emitting unit judges the logic of the input-side cascade signal line. When the input-side cascade signal line is logic 1, the signal line between the control section and the light-emitting driving circuit is set to logic 1 so as to turn on the light-emitting body, and the cascade signal line branched from the signal line to reach the control section of the next light-emitting unit is set to logic 1. When the input-side cascade signal line is set to logic 0, the next address from the address stored in the register is obtained on the basis of a predetermined operation rule, and the address of the register is updated into the next address. On the basis of whether the counted input number of the second control signals becomes the total number of light-emitting units, or on the basis of the input of a third control signal which is transmitted from the bus-connected signal line after the second control signals are output as many as the total number of light-emitting units, the respective addresses stored in the registers are written into the nonvolatile memories. When normal address setting is impossible, the signal line between the control section and the light-emitting body driving circuit is set to logic 0 so as to turn off the light emitting body.

In the invention, the construction of another embodiment may be added, the construction of each embodiment may be modified, and the construction of each embodiment may be partially removed within a predetermined limit. Further, as the light-emitting body, a suitable light-emitting body other than the LED can be used.

In the light-emitting unit system of the invention, an address can be set in the bus-connected light-emitting unit through a control signal transmitted by operating the address setting device. Therefore, an address can be efficiently set in each light-emitting unit with little labor. Further, the light-emitting body is turned on and off with the address setting being performed, so that it can be easily checked whether an address is normally set in each light-emitting unit. In addition, an address can be set in each light-emitting unit by using an existing signal line transmitting a dimming control signal and a signal line transmitting a driving control signal of an LED driving circuit. Therefore, it is possible to set an address without using special equipment such as a signal line for setting an address.

Further, a control signal related to the address setting is transmitted, and the first light-emitting unit sets an initial address on the basis of the control signal. For example, the initial address is incremented by a predetermined value so as to be an address of the next light-emitting unit, and an address of the next light-emitting unit is determined according to a predetermined operation rule. Then, it is possible to set an address in each light-emitting unit through simple processing, without special address management or transmission of address. On the other hand, when an address set by the bus-connected signal line is transmitted to the light-emitting unit, an arbitrary address can be allocated to the light-emitting unit.

After a control signal is input so that the addresses set in all the light-emitting units are held, the addresses are simultaneously written in the all the light-emitting units. Then, it is possible perform writing after the validity of a control signal related to the address setting is verified. Further, the verification of validity can be easily and reliably carried out, and the address setting process can be prevented from being abnormally terminated due to the interruption of writing operation. In addition, the address setting is performed in a state where the addresses with respect to all the light-emitting units are held. Therefore, without waiting for the time until the address writing operation of the previous light-emitting unit is terminated, it is possible to perform processing for holding an address in the next light-emitting unit.

The invention can be utilized in the address setting of an LED unit or the like which is used as a pixel of an LED display device with a large screen, for example.

### BRIEF DESCRIPTION OF THE DRAWINGS

FIG. 1 is a block diagram illustrating an LED unit system according to first to fourth embodiments of the invention;

FIG. 2 is a flow chart showing an address setting procedure according to a first embodiment;

FIG. 3 is a flow chart showing an address setting procedure according to a second embodiment;

FIG. 4 is a flow chart showing an address setting procedure according to a third embodiment;

FIG. 5 is a flow chart showing an address setting procedure according to a fourth embodiment;

FIG. 6A is a plan view illustrating an example of an LED unit;

FIG. 6B is a front view of the example of the LED unit; and

FIG. 6C is a side view of the example of the LED unit.

### DESCRIPTION OF THE PREFERRED EMBODIMENTS

A light-emitting unit system of the invention will be described on the basis of LED unit systems of first to fourth embodiments.

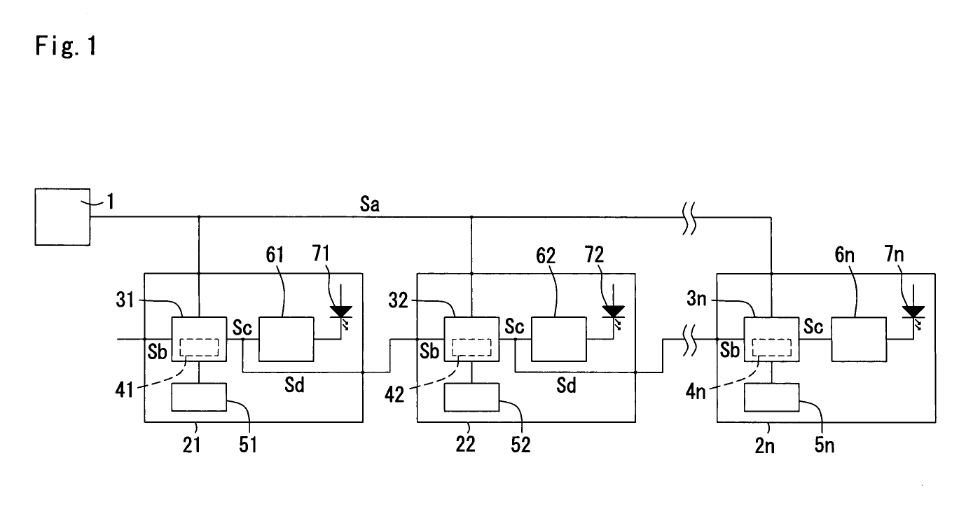

First, the LED unit system according to the first to fourth embodiments is constructed so that LED units 2i (1≦i≦n) are bus-connected and cascade-connected, as shown in FIG. 1. The LED units 21, 22, . . . , 2n are bus-connected to an address setting device 1 by a signal line Sa. The address setting device 1 is provided with a control section which operates in accordance with a control program, a memory section, a timer, an operation input section and so on. The address setting device 1 outputs an address write starting signal and an address write instructing signal, to be described later, to transmit to each LED unit 2i through the signal line Sa. The bus-connected signal line Sa serves to transmit a dimming control signal after address setting.

The LED unit 2i has a blue LED 7i (1≦i≦n) and a microprocessor 3i (1≦i≦n) therein. The microprocessor 3i (1≦i≦n) has a built-in memory such as a flash memory or RAM. The flash memory stores a control program, and the RAM is a data processing region. Reference numeral 4i (1≦i≦n) represents a register within the microprocessor 3i. Inside the LED unit 2i, a rewritable nonvolatile memory 5i (1≦i≦n) such as EEPROM and an LED driving circuit 6i (1≦i≦n) for turning on and off the LED 7i are provided so as to be respectively connected to microprocessor 3i. Further, although not shown in FIG. 1, the LED unit 2i has red and green LEDs in addition to the blue LED 7i. The three primary colors of LEDs are turned on and off by the LED driving circuit 6i. Further, the LED unit 2i has a power supply system (not shown).

The microprocessor 3i is connected to signal lines Sb and Sc, respectively, into which a driving control signal of the LED driving circuit 6i is input. The microprocessor 3i and the LED driving circuit 6i are connected through the signal line Sc, and a signal line Sd is branched from the signal line Sc. The branched signal line Sd is connected to the signal line Sb of the next LED unit 2(i+1). That is, the LED unit 2i and the LED unit 2(i+1) are cascade-connected to each other through the signal lines Sb and Sd.

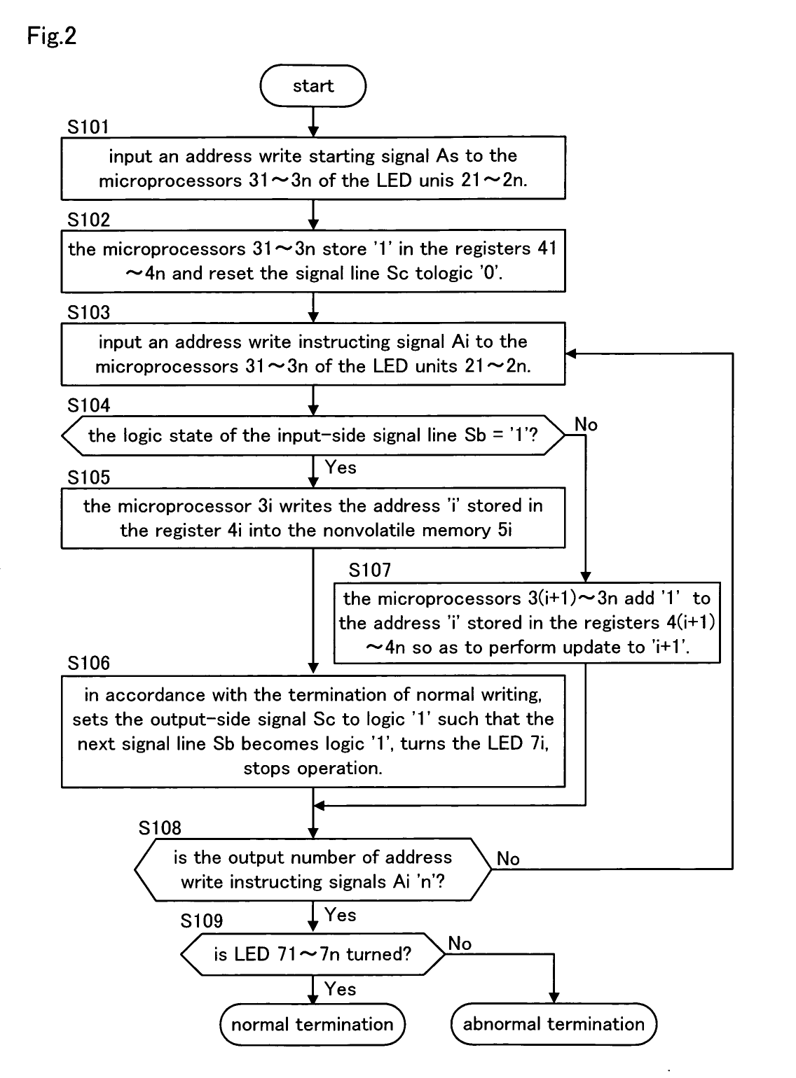

Next, address setting in the light-emitting unit system according to a first embodiment will be described with reference to FIG. 2. In the address setting of the first embodiment as shown in FIG. 2, the address setting device 1 outputs an address write starting signal As in accordance with operation input, and the address write starting signal is input to the microprocessor 31, 32, . . . , 3n of the respective LED units 21, 22, . . . , 2n through the bus-connected signal line Sa (S101). In accordance with the input of the address write starting signal As, the respective microprocessors 31, 32, . . . , 3n store ‘1’ as an initial address in the respective registers 41, 42, . . . , 4n. Further, between logic 0 and logic 1 specified in a predetermined voltage range, the microprocessors 31, 32, . . . , 3n set the signal line Sc to logic 0, and set the signal line Sd branched from the signal line Sc and the signal line Sb of the next LED unit 2i continuing or connected to the signal line Sd to logic 0. In other words, the respective microprocessors reset all the signal lines Sb, Sc, and Sd to logic 0, except for the signal line Sb of the first LED unit 21 (S102). Further, the signal line Sb of the first LED unit 21 is always set to logic 1 due to a load of predetermined voltage.

After that, the address setting device 1 outputs an address write instructing signal A1 in accordance with operation input, and the address write instructing signal A1 is input to the microprocessors 31 to 3n of the respective LED units 21 to 2n through the bus-connected signal line Sa (S103). In accordance with the input of the address write instructing signal A1, the microprocessors 31 to 3n judge whether the logic state of the input-side signal line Sb is logic 0 or logic 1, through voltage checking (S104).

As a result of the judgment, the microprocessor 31 of the first LED unit 21, in which the input-side signal line Sb is set to logic 1, writes the address ‘1’ as an address of the LED unit 21 into the nonvolatile memory 51, the address ‘1’ being stored in the register 41 (S105). In accordance with the termination of normal writing, the microprocessor 31 set the output-side signal line Sc to logic 1. On the basis of a state where the signal line Sc is set to logic 1, the signal line Sd branched from the signal line Sc and the signal line Sb of the next LED unit 22 continuing to the signal line Sd become logic 1. The LED driving circuit 61, into which logic 1 is input, turns on the LED 71 through lighting control and informs that the address of the LED unit 21 is normally written. After that, the microprocessor 31 stops operation until it recognizes the termination of address writing of all the LED units 21 to 2n through a write termination signal (S106). On the other hand, as a result of the determination in S104, the microprocessors 32 to 3n of the LED units 22 to 2n, in which the input-side signal line Sb is set to logic 0, add 1 as an additional value in the address ‘1’ stored in the registers 42 to 4n so as to perform update, and store an address 121 in the respective registers 42 to 4n (S107). Moreover, a suitable value other than 1 may be set as the initial address or additional value.

In accordance with the output of the address write instructing signal A1, the address setting device 1 judges whether or not address write instructing signals Ai are output as many as the total number n of the LED units 21 to 2n (S108). If not, a predetermined time which is set is measured by the timer. As the predetermined time lapses, the address setting device 1 outputs an address write instructing signal A2 and executes the same processing as the steps S103 to S107. Further, the address setting device 1 repeatedly executes the same processing until it outputs an address write instructing signal An. That is, the address setting device 1 outputs an address write instructing signal Ai and inputs the address write instructing signal Ai into the respective microprocessors 31 to 3n. In accordance with the input, the microprocessors 3i to 3n of the respective LED units 2i to 2n other than the LED unit, in which address setting is completed so that the operation thereof is stopped, judge whether the logic of the signal line Sb is 0 or 1. The microprocessor 3i of the LED unit 2i, in which the signal line Sb is logic 1, writes the address ‘i’ of the register 4i into the nonvolatile memory 5i. Then, the microprocessor 3i sets the output-side signal line Sc to logic 1 in accordance with the termination of normal writing, sets the logic of the continuing signal line Sd and the signal line Sb of the next LED unit 2(i+1) to 0, and stops the operation. Further, the LED driving circuit 6i, into which logic 1 is input, turns on the LED 7i. On the other hand, the microprocessors 3(i+1) to 3n of the LED units 2(i+1) to 2n, in which the input-side signal line Sb is logic 0, add 1 to the address ‘i’ stored in the respective registers 4(i+1) to 4n so as to perform update, and store an address ‘i+1’ in the respective registers 4(i+1) to 4n.

The address setting device 1 outputs the final address write instructing signal An. The microprocessor 3n of the LED unit 2n receiving the address write instructing signal An writes an address ‘n’ of the register 4n into the nonvolatile memory 5n, sets the output-side signal line Sc to logic 1, and stops operation. Further, the driving circuit 6n into which logic 1 is input turns on the LED 7n. Then, the address write instructing signals Ai are completely output as many as the total number n of the LED unit 21 to 2n. In this case, it is checked whether all the LEDs 71, 72, . . . , 7n are turned on (S109). When all the LEDs are turned on, the address setting is completed.

When the microprocessor 3i writes the address ‘i’ stored in the register 4i into the nonvolatile memory 5i, the judgment on whether the writing is normally carried out or not is performed as follows. For example, the microprocessor 3i of the LED unit 2i reads the address written in the nonvolatile memory 5i, compares the address with the address which is temporarily stored register 4i, and judges whether both of the addresses coincide with each other. Further, when the writing cannot be normally performed, the signal line connecting the microprocessor 3i and the LED driving circuit of the red LED is set to 1, and the red LED is turned on. That is, the LED may be turned on in a light-emission pattern showing abnormalities.

In the address setting according to the first embodiment, the output-side signal line Sc is set to logic 1 and the LED 7i is turned on in the respective LED units 2i, as the writing of the LED address i into the nonvolatile memory 5i is normally terminated. Therefore, it can be easily checked by the turn-on state of the LED 7i whether the address i is normally written into each LED unit 2i. In other words, if the LED 7n of the final LED unit 2n is turned on, it can be found that the addresses are normally set in all the LED units 21 to 2n, and the checking operation of the address setting becomes very easy. Further, without the address itself being transmitted from the address setting device 1, the initial address or the previous address is incremented by a setting value so as to be set to the next address. Therefore, it is possible to set an address through the simple processing.

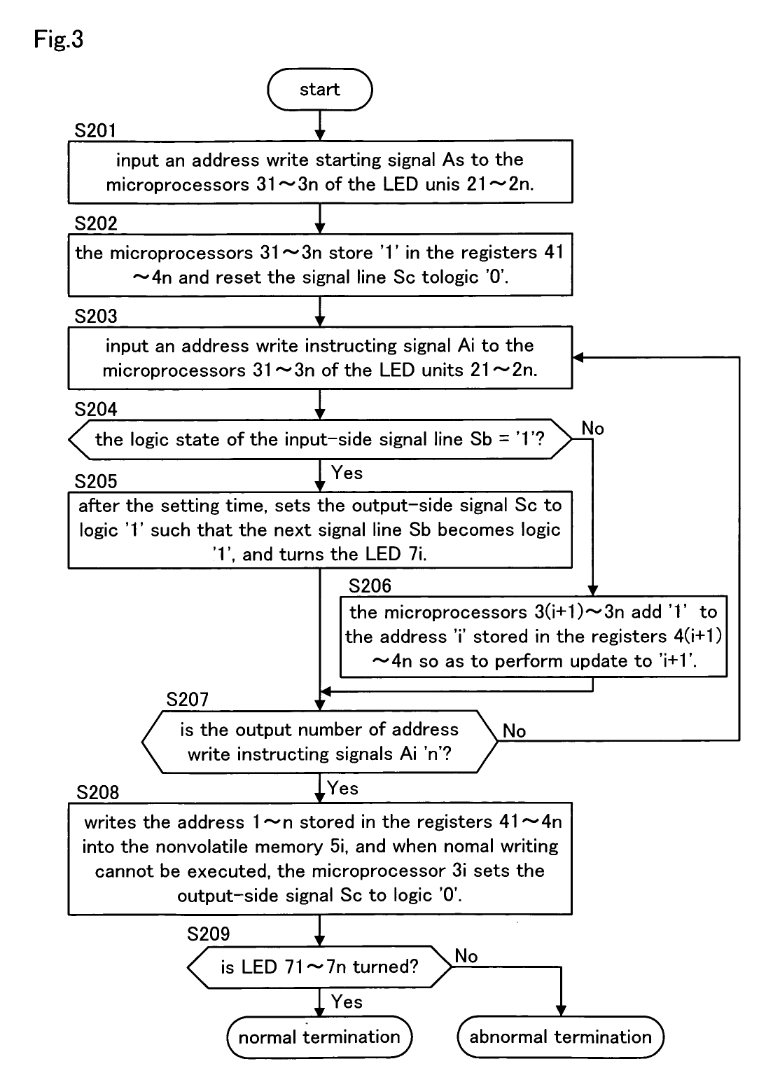

Next, address setting in a light-emitting unit system according to a second embodiment will be described, and the same components as those of the first embodiment will not be described. In the address setting of the second embodiment shown in FIG. 3, steps S201 to 204 which are performed the same as the steps S101 to S104 are executed. As a result of logic judgment in the step S204, the microprocessor 31 of the first LED unit 21, in which the input-side signal line Sb is logic 1, sets the signal line Sc to logic 1 after the setting time set in the control program elapses. Further, the microprocessor 31 set the signal line Sd branched from the signal ling Sc and the signal line Sb of the next LED unit 22 to logic 1, the signal line Sb continuing to the signal line Sd, and the LED driving circuit 61 into which logic 1 is input turns on the LED 71 through lighting control (S205). On the other hand, as a result of the determination in S204, the microprocessors 32 to 3n of the LED units 22 to 2n, in which the input-side signal line Sb is logic 0, add 1 to the address ‘1’ stored in the register 42 to 4n so as to perform update, and store an address ‘2’ in the respective register 42 to 4n (S206). Further, the respective microprocessors 31 and 3n count the input number of address write instructing signals Ai so as to hold in a predetermined region of the memory and sequentially update the input number in accordance with the input.

After that, when the address write instructing signals Ai are not output as many as the total number n of the LED units 21 to 2n (S207), the same processing as the steps S203 to S206 is repeatedly executed. That is, the address write signal Ai output by the address setting device 1 is input into the microprocessors 31 to 3n of the respective LED units 21 to 2n, and in accordance with the input, the respective microprocessors 3i to 3n judge whether the input-side signal line Sb is logic 0 or logic 1. The microprocessor 3i of the LED unit 2i, in which the input-side signal line Sb is logic 1, sets the signal line Sc, the signal line Sd branched from the signal line Sc and the signal line Sb of the next LED unit 2(i+1) continuing to the signal line Sd to logic 1, after a predetermined time set in the control program elapses from the judgment of logic 1. Further, the LED driving circuit 6i turns on the LED 7i through lighting control, and the microprocessor 3i stops operation. On the other hand, the microprocessors 3(i+1) to 3n of the LED units 2(i+1) to 2n, in which the input-side signal line Sb is logic 0, add 1 to the address ‘i’ stored in the registers 4(i+1) to 4n so as to perform update, and store an address ‘i+1’ in the registers 4(i+1) to 4n.

The address setting device 1 outputs the final address write instructing signal An, the microprocessor 3n of the LED unit 2n receiving the address write instructing signal An sets the signal line Sc to logic 0 after a predetermined time set in the control program elapses from the judgment of logic 1, and the LED driving circuit 6n turns on the LED 7n. Further, the microprocessors 31 to 3n recognize that the input number of address write instructing signals Ai, which is being counted, becomes the total number n of the LED units 21 to 2n (S207). In this case, the microprocessors 31 to 3n of the respective LED units 21 to 2n write the address 1 to n stored in the respective registers 41 to 4n into the nonvolatile memories 51 to 5n, after a predetermined time elapses from when the input number has reached n (S208). At this time, when normal writing cannot be executed, the microprocessor 3i of the LED unit 2i sets the connected signal line Sc to logic 0, and the LED driving circuit 6i turns off the LED 7i (S208). Finally, it is checked whether all the LED units 71, 72, . . . , 7n are turned on (S209). When all the LED units are turned on, the address setting is completed.

Instead of the above-described construction, and in the step S205 where the LED 7i is turned on, the microprocessor 3i of the LED unit 2i stops operation until an address write operating signal Aw is input, and the address setting device 1 counts the output number of address write instructing signals Ai. When the address write instructing signals Ai are output as many as the total number n of the LED units 21 to 2n, the address setting device 1 counts a predetermined time and outputs an address write operation signal Aw after the predetermined time elapses. On the other hand, the microprocessors 31 to 3n of the respective LED units 21 to 2n may write the address 1 to n stored in the respective registers 41 to 4n into the nonvolatile memories 51 to 5n in accordance with the input of the address write operation signal Aw.

In the address setting according to the second embodiment, the writing of address i into the nonvolatile memory 5i is held until the address write starting signal As and all the address write instructing signals A1 to An are transmitted, and the address is written after the validities of the address write starting signal As and all the address write instructing signals A1 to An are verified. Therefore, it is possible to easily and reliably perform the verification of validity such as a redundant format or the like. Further, without waiting for the time until the respective LED units 2i completely write the address into the nonvolatile memories 5i, it is possible to rapidly output the next address write instructing signal A(i+1) and to set the address within a short time. In addition, the LED unit 2i, in which the normal writing cannot be performed, turns off the LED 7i, and the LED unit 2i, in which the normal writing can be performed, maintains the turn-on state. Therefore, it is possible to easily check the normal setting of address. Further, since the LED units 21 to 2n simultaneously write the addresses 1 to n into the nonvolatile memories 51 to 5n, the address setting can be prevented from being abnormally terminated due to the interruption of writing operation. In addition, without transmitting the address from the address setting device 1, the initial address or the previous address is incremented by a setting value so as to be set to the next address. Therefore, it is possible to set the addresses through the simple processing.

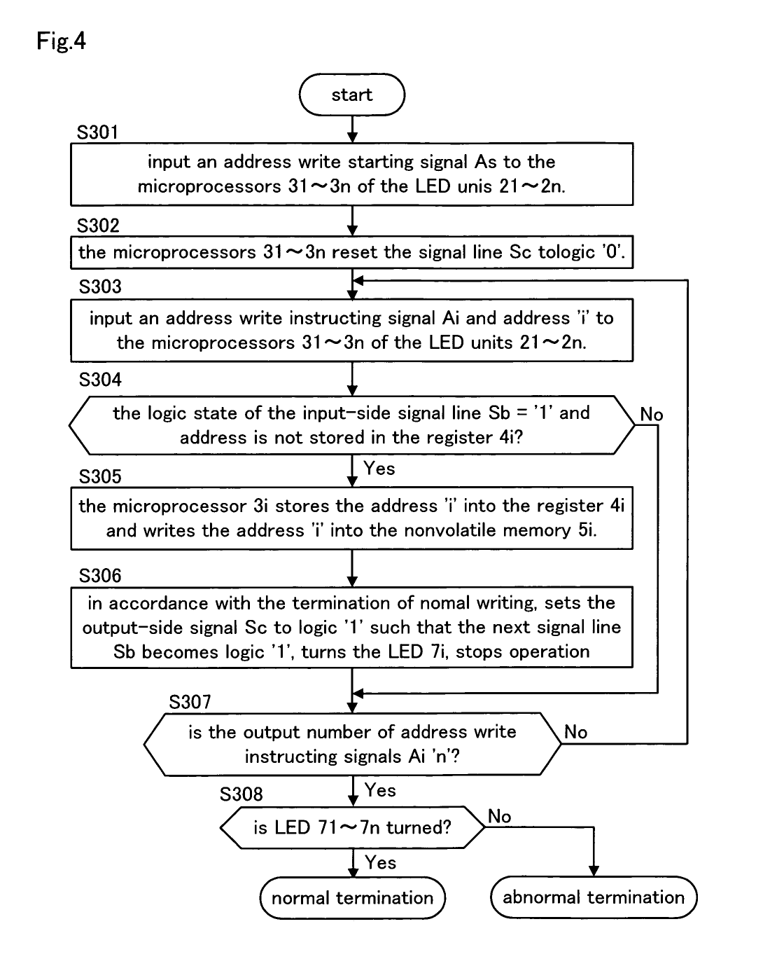

Next, address setting in a light-emitting unit system according to a third embodiment will be described, and the same components as those of the first embodiment will not be described. In the address setting of the third embodiment shown in FIG. 4, the address setting device 1 outputs an address write starting signal As in accordance with an operation input, and the address write starting signal As is input to the microprocessors 31, 32, . . . , 3n of the respective LED units 21, 22, . . . , 2n through the bus-connected signal line Sa (S301). In accordance with the input of the address write starting signal As, the respective microprocessors 31 to 3n set the signal line Sc to logic 0. Further, the microprocessors 31 to 3n set the signal line Sd branched from the signal line Sc and the signal line Sb of the next LED unit 2i continuing to the signal line Sd to logic 0. That is, the all the signal lines Sb, Sc, and Sd other than the signal line Sb of the LED unit 21 are reset to logic 0 (S302).

After that, the address setting device 1 outputs an address write instructing signal A1 and an address ‘1’ in accordance with operation input, and the address write instructing signal A1 and the address ‘1’ are input to the microprocessors 31 to 3n of the respective LED units 21 to 2n through the bus-connected signal line Sa (S303). In accordance with the input of the address write instructing signal A1, the microprocessors 31 to 3n judges through voltage checking or the like whether the logic state of the input-side signal line Sb is logic 0 or logic 1 and whether the addresses are stored in the respective registers 41 to 4n (S304).

As a result of the judgment in the step S304, the microprocessor 31 of the first LED unit 21, in which the input-side signal line Sb is logic 1 and an address is not stored in the register 41, stores the input address ‘1’ into the register 41 and writes the address ‘1’ stored in the register 41 into the nonvolatile memory 51 as an address of the LED unit 21 (S305). Further, the microprocessor 31 sets the output-side signal line Sc to logic 1 in accordance with the termination of normal writing. On the basis of the state where the signal line Sc is logic 1, the microprocessor 31 sets the signal line Sd branched from the signal line Sc and the signal line Sb of the next LED unit 22 continuing to the signal line Sd to logic 1. Further, the LED driving circuit 61 into which logic 1 is input turns on the LED 71 through lighting control and informs that the address of the LED unit 21 is normally written. After that, the microprocessor 31 stops operation until it recognizes the termination of address writing of all the LED units 21 to 2n through a write termination signal or the like (S306).

After the processing of the step S306, or when it is judged in the step S304 that the signal line Sb is not logic 1 or when an address is not set in the register 4i, it is judged whether the address write instructing signals Ai are output as many as the total number n of the LED units 21 to 2n or not (S307), and the same processing as the steps S303 to S306 is repeatedly executed. That is, the address write instructing signals Ai and the addresses ‘i’ output from the address setting device 1 are respectively input to the microprocessors 31 to 3n of the LED units 21 to 2n through the bus-connected signal line Sa, and the microprocessors 3i to 3n of the respective LED units 2i to 2n other than the LED unit, in which the address setting is completed, judge whether the logic of the signal line Sb is 0 or 1 and whether addresses are stored in the respective registers 4i to 4n, in accordance with the input. Further, the microprocessor 3i of the LED unit 2i, in which the input-side signal line Sb is logic 1 and an address is not stored in the register 4i, stores the input address ‘i’ into the register 4i and writes the address ‘i’ stored in the register 4i into the nonvolatile memory 5i as an address of the LED unit 2i. The output-side signal line Sc, the signal line Sd branched from the signal line Sc, and the signal line Sb of the next LED unit 2(i+1) continuing to the signal line Sd are set to logic 1 in accordance with the termination of normal writing. Further, the LED driving circuit 6i turns on the LED 7i, and the microprocessor 3i stops operation.

Then, the address setting device 1 outputs a final address write instructing signal An and an address ‘n’. The microprocessor 3n of the LED unit 2n, receiving the address write instructing signal An and the address ‘n’, stores the input address ‘n’ into the register 4n and writes the input address ‘n’ into the nonvolatile memory Sn, on the basis of the judgment that the signal line Sb is logic 1 and an address is not stored in the register 4n. In accordance with the termination of normal writing, the microprocessor 3n sets the output-side signal line Sc to logic 1, and stops operation after the LED driving circuit 6n turns on the LED 7n. Finally, it is checked whether all the LEDs 71, 72, . . . , 7n are turned on (S308). When all the LEDs are turned on, the address setting is completed.

In the address setting of the third embodiment, the output-side signal line Sc is set to logic 1 and the LED 7i is turned on in the respective LED units 2i, in accordance with the termination of normal writing of the LED address i into the nonvolatile memory 5i. Therefore, the normal writing of the address i into each LED unit 2i can be easily checked through the turn-on state of the LED 7i. In other words, if the LED 7n of the final LED unit 2n is turned on, it can be found that the addresses are normally set in all the LED units 21 to 2n, and the checking operation of the address setting can be easily carried out. Further, since the address i is output to the LED unit 2i in addition to the address write instructing signal Ai, an arbitrary address can be allocated to the LED unit 2i.

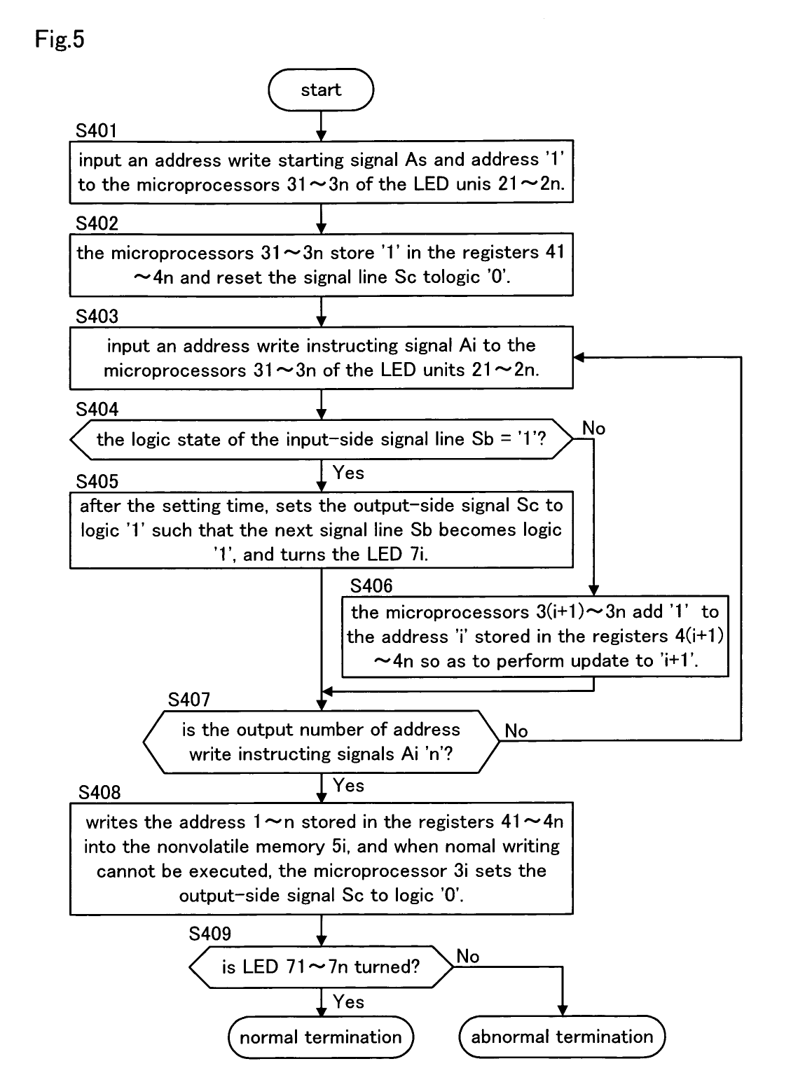

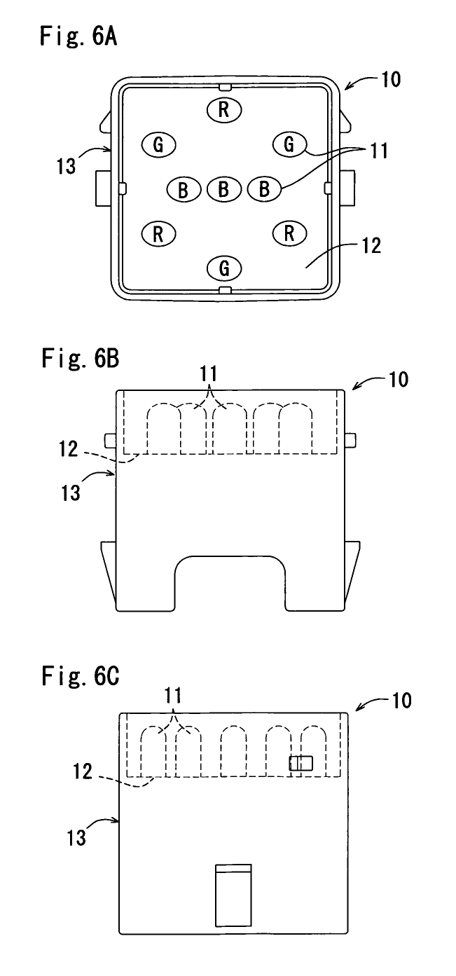

Next, address setting in a light-emitting unit system according to a fourth embodiment will be described. Although basic processing in the fourth embodiment of FIG. 5 is the same as that of the second embodiment, the microprocessor 3i stores an initial address ‘1’, input with an address write starting signal As, into the register 4i, instead of the construction in which the microprocessor 3i stores the initial address ‘1’ set in the program into the register 4i. That is, the address setting device 1 outputs the address write starting signal As and the address 11l in accordance with operation input, and the address write starting signal As and the address ‘1’ are input to the microprocessors 31, 32, . . . , 3n of the respective LED units 21, 22, . . . , 2n through the bus-connected signal line Sa (S401). In accordance with the input of the address write starting signal As, the respective microprocessors 31, 32, . . . , 3n store the input address ‘1’ into the respective registers 41, 42, . . . , 4n. Further, the microprocessors 31, 32, . . . , 3n set the signal line Sc to logic 0 and set the signal line Sd branched from the signal line Sc and the signal line Sb of the next LED unit 21 continuing and connected to the signal line Sd to logic 0. That is, all the signal lines Sb, Sc, and Sd other than the signal line Sb of the first LED unit 21 are reset to logic 0 (S402). The other construction is the same as that of the second embodiment, and the steps 403 to 409 correspond to the steps S203 to S209, respectively.

In the address setting according to the fourth embodiment, the writing of address i into the nonvolatile memory 5i is held until the address write starting signal As and all the address write instructing signals A1 to An are transmitted, and the address are written after the validities of the address write starting signal As and the address write instructing signals A1 to An are verified. Therefore, it is possible to easily and reliably perform the verification of the validities. Further, without waiting for the time until the address writing into the nonvolatile memory 5i of each LED unit 2i is terminated, the next address write instructing signal A(i+1) can be rapidly output, and the address setting can be carried out in a short time. Further, the LED unit 2i in which normal writing cannot be performed turns off the LED 7i, and the LED unit 2i in which normal writing can be performed maintains the turn-on state. Therefore, it is possible to easily check if the address setting is normally carried out. In addition, since the LED units 21 to 2n simultaneously writes the addresses 1 to n into the nonvolatile memories 51 to 5n, the address setting can be prevented from being abnormally terminated due to the interruption of writing operation. Further, the address setting device 1 outputs the initial address, and the initial address or the previous address of the LED unit 21 is incremented by a setting value so as to be set to the next address. Therefore, the address setting can be carried out through the simple processing.

What is claimed is:

1. A light-emitting unit system comprising:
light-emitting units each having a control section, a nonvolatile memory, and a light-emitting body driving circuit built therein, the light-emitting units being bus-connected and cascade-connected to each other and an address being set to the respective light-emitting units on the basis of a control signal input from a bus-connected signal line,
wherein an input-side cascade signal line of the first light-emitting unit is set to logic 1,
on the basis of a first control signal input from the bus-connected signal line, the control section of each light emitting unit stores a set initial address into a register and sets a signal line between the control section and the light-emitting driving circuit and a cascade signal line branched from the signal line to reach the control section of the next light-emitting unit to logic 0,
on the basis of second control signals input from the bus-connected signal line which are sequentially transmitted to correspond to the address setting of the respective light-emitting units, the control section of each light-emitting unit judges the logic of the input-side cascade signal line,
when the input-side cascade signal line is logic 1, the address stored in the register is written into the nonvolatile memory, the signal line between the control section and the light-emitting driving circuit is set to logic 1 so as to turn on a light-emitting body, and the cascade signal line branched from the signal line so as to reach the control section of the next light-emitting unit is set to logic 1, and
when the input-side cascade signal line is logic 0, the next address from the address stored in the register is obtained on the basis of a predetermined operation rule, and the address of the register is updated into the next address.

2. A light-emitting unit system comprising:
light-emitting units each having a control section, a nonvolatile memory, and a light-emitting body driving circuit built therein, the light-emitting units being bus-connected and cascade-connected to each other and an address being set to the respective light-emitting units on the basis of a control signal input from a bus-connected signal line,
wherein an input-side cascade signal line of the first light-emitting unit is set to logic 1,
on the basis of a first control signal input from the bus-connected signal line, the control section of each light emitting unit stores a set initial address into a register and sets a signal line between the control section and the light-emitting driving circuit and a cascade signal line branched from the signal line to reach the control section of the next light-emitting unit to logic 0,
on the basis of second control signals input from the bus-connected signal line which are sequentially transmitted to correspond to the address setting of the respective light-emitting units, the control section of each light-emitting unit judges the logic of the input-side cascade signal line,
when the input-side cascade signal line is logic 1, the signal line between the control section and the light-emitting driving circuit is set to logic 1 so as to turn on a light-emitting body, and the cascade signal line branched from the signal line so as to reach the control section of the next light-emitting unit is set to logic 1,
when the input-side cascade signal line is logic 0, the next address from the address stored in the register is obtained on the basis of a predetermined operation rule, and the address of the register is updated into the next address,
on the basis of whether the counted input number of second control signals becomes the total number of light-emitting units, or on the basis of the input of a third control signal which is transmitted from the bus-connected signal line after the second control signals are output as many as the total number of light-emitting units, the respective addresses stored in the registers are written into the nonvolatile memories, and
when normal address setting is impossible, the signal line between the control section and the light-emitting body driving circuit is set to logic 0 so as to turn off the light emitting body.

3. A light-emitting unit system comprising:
light-emitting units each having a control section, a nonvolatile memory, and a light-emitting body driving circuit built therein, the light-emitting units being bus-connected and cascade-connected to each other and an address being set to the respective light-emitting units on the basis of a control signal input from a bus-connected signal line,
wherein an input-side cascade signal line of the first light-emitting unit is set to logic 1,
on the basis of a first control signal input from the bus-connected signal line, the control section of each light-emitting unit sets a signal line between the control section and the light-emitting driving circuit and a cascade signal line branched from the signal line to reach a control section of the next light-emitting unit to logic 0,
on the basis of second control signals and addresses input from the bus-connected signal line which are sequentially transmitted so as to correspond to the address setting of the respective light-emitting units, the control section of each light-emitting unit judges the logic of the input-side cascade signal line and whether an address is not stored in a register,
when the input-side cascade signal line is logic 1 and an address is not stored in the register, the input address is stored in the register and is written into the nonvolatile memory, the signal line between the control section and the light-emitting driving circuit is set to logic 1 so as to turn on a light-emitting body, and the cascade signal line branched from the signal line so as to reach the control section of the next light-emitting unit is set to logic 1.

4. A light-emitting unit system comprising:
light-emitting units each having a control section, a nonvolatile memory, and a light-emitting body driving circuit built therein, the light-emitting units being bus-connected and cascade-connected to each other and an address being set to the respective light-emitting units on the basis of a control signal input from a bus-connected signal line,
wherein an input-side cascade signal line of the first light-emitting unit is set to logic 1,
on the basis of a first control signal and an initial address input from the bus-connected signal line, the control section of each light emitting unit stores the input initial address into a register and sets a signal line between the control section and the light-emitting driving circuit and a cascade signal line branched from the signal line to reach a control section of the next light-emitting unit to logic 0,
on the basis of second control signals input from the bus-connected signal line which are sequentially transmitted to correspond to the address setting of the respective light-emitting units, the control section of each light-emitting unit judges the logic of the input-side cascade signal line,
when the input-side cascade signal line is logic 1, the signal line between the control section and the light-emitting driving circuit is set to logic 1 so as to turn on the light-emitting body, and the cascade signal line branched from the signal line to reach the control section of the next light-emitting unit is set to logic 1,
when the input-side cascade signal line is set to logic 0, the next address from the address stored in the register is obtained on the basis of a predetermined operation rule, and the address of the register is updated into the next address,
on the basis of whether the counted input number of the second control signals becomes the total number of light-emitting units, or on the basis of the input of a third control signal which is transmitted from the bus-connected signal line after the second control signals are output as many as the total number of light-emitting units, the respective addresses stored in the registers are written into the nonvolatile memories, and
when normal address setting is impossible, the signal line between the control section and the light-emitting body driving circuit is set to logic 0 so as to turn off the light emitting body.
